(19) United States
(12) Patent Application Publication
(10) Pub. No.: US 2022/0198811 A1
(43) Pub. Date: Jun. 23, 2022

(54) PARKING LOT CORNER POINT CORRECTION METHOD, PARKING LOT CORNER POINT CORRECTION SYSTEM, AND VEHICLE

(71) Applicant: NIO TECHNOLOGY (ANHUI) CO., LTD, Hefei City (CN)

(72) Inventors: Junyi DAI, Hefei City, Anhui (CN); Shiting WANG, Hefei City, Anhui (CN)

(21) Appl. No.: 17/549,187

(22) Filed: Dec. 13, 2021

(30) Foreign Application Priority Data
Dec. 18, 2020 (CN) 202011509067.X

(51) Int. Cl. G06V 20/58; G06V 10/44; G06T 7/60; G06T 7/70; G06T 7/50

(52) U.S. Cl. CPC G06V 20/586; G06V 10/44; G06T 7/60; G06T 2207/30264; G06T 7/50; G06T 2207/20164; G06T 7/70

(57) ABSTRACT

The invention relates to a parking lot corner point correction method and system. The method includes: an obtaining step of obtaining a parking lot corner point of a parking lot; and a correction step of performing, based on a position relationship between parking lot corner points of the parking lot, rectangular correction on the parking lot corner points to obtain a corrected parking lot. The obtaining step includes: a first obtaining sub-step of obtaining a parking lot corner point of a parking lot; a determination sub-step of determining whether a corner point confidence level of the parking lot corner point meets a first threshold and whether a corner point offset thereof meets a second threshold, and jumping to the correction step if it is determined that the corner point confidence level meets the first threshold and the corner point offset meets the second threshold, otherwise, proceeding to a second obtaining sub-step; and the second obtaining sub-step of discarding the parking lot corner point of the parking lot that is detected in the first obtaining sub-step, and then using a parking lot corner point at a corresponding position that is predicted by an odometer, as the parking lot corner point of the parking lot. According to the invention, the parking accuracy may be improved.

### CROSS-REFERENCE TO RELATED APPLICATION

This application claims the benefit of Chinese Patent Application No. 202011509067.X filed Dec. 18, 2020, the entire contents of which are incorporated herein by reference in its entirety.

### TECHNICAL FIELD

The invention relates to vehicle control technology, and in particular to a parking lot corner point correction method, a parking lot corner point correction system, and a vehicle including the parking lot corner point correction system.

### BACKGROUND ART

Currently, the most widely applied parking lot detection algorithms all involve the detection of four corner points of a parking lot, so that a parking lot is formed based on the four corner points. In a single-frame image, as long as the deviation of a corner point from a true value is within a certain range, it can be considered that the detection result is correct, and there is no jitter. However, in a video stream, once there is a certain deviation between detection results of two adjacent frames, a jitter may occur to the whole parking lot, and the parking lot may become an irregular quadrangle, resulting in unpredictable deviations in automatic parking.

### SUMMARY OF THE INVENTION

In view of the above problem, the invention aims to provide a parking lot corner point correction method, a parking lot corner point correction system, and a vehicle including the parking lot corner point correction system, so as to improve the parking accuracy.

An aspect of the invention provides a parking lot corner point correction method, the method including:

an obtaining step of obtaining a parking lot corner point of a parking lot; and

a correction step of performing, based on a position relationship between parking lot corner points of the parking lot, rectangular correction on the parking lot corner points to obtain a corrected parking lot.

Optionally, the obtaining step includes:

a first obtaining sub-step of obtaining a parking lot corner point of a parking lot;

a determination sub-step of determining whether a corner point confidence level of the parking lot corner point meets a first threshold and whether a corner point offset of the parking lot corner point meets a second threshold, and jumping to the correction step if it is determined that the corner point confidence level of the parking lot corner point meets the first threshold and the corner point offset of the parking lot corner point meets the second threshold, otherwise, proceeding to a second obtaining sub-step; and

the second obtaining sub-step of discarding the parking lot corner point of the parking lot that is detected in the first obtaining sub-step, and then using a parking lot corner point at a corresponding position that is predicted by an odometer, as the parking lot corner point of the parking lot.

Optionally, the correction step includes:

forming four sides by the parking lot corner points of the parking lot, and obtaining four rectangles separately by taking one side in the four sides as a reference and taking the depth as a mean of the side length of the side; and taking, from among the four rectangles and as the corrected parking lot, a rectangle with the maximum confidence level on a thermodynamic diagram.

Optionally, the confidence level of the rectangle on the thermodynamic diagram is obtained by means of the levels of confidence of the four corner points of the rectangle on the thermodynamic diagram.

Optionally, the confidence levels on the thermodynamic diagram are obtained by means of a corner point prediction model.

Optionally, the correction step includes:

selecting two sides from four sides formed by the parking lot corner points of the parking lot, and calculating a center line of the two sides;

obtaining a parking lot entrance line segment of the parking lot according to a position relationship between a vehicle and the parking lot corner point of the parking lot;

obtaining a point at which the center line intersects with the parking lot entrance line segment; and

based on the position of the intersection point and the positions of the two sides, performing rectangular correction on the parking lot corner point by using a geometric relationship to obtain the corrected parking lot.

Optionally, if the two sides are parallel, a line which is parallel to the two sides and has an equal distance to the two sides is taken as a center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

Optionally, if the two sides are not parallel, an angular bisector of an angle formed by extension lines of the two sides is used as the center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

An aspect of the invention provides a parking lot corner point correction system, the system including:

an obtaining module for obtaining a parking lot corner point of a parking lot; and

a correction module for performing, based on a position relationship between parking lot corner points of the parking lot, rectangular correction on the parking lot corner points to obtain a corrected parking lot.

Optionally, the obtaining module includes:

a first obtaining sub-module configured to obtain a parking lot corner point of a parking lot;

a determination sub-module configured to determine whether a corner point confidence level of the parking lot corner point acquired by the first obtaining sub-module meets a first threshold and whether a corner point offset of the parking lot corner point meets a second threshold, and then output a determination result; and

a second obtaining sub-module configured to obtain a parking lot corner point at a corresponding position that is predicted by an odometer; and

an output module configured to provide, based on the determination result from the determination sub-module and to the correction module, the parking lot corner point output by the first obtaining sub-module or the parking lot corner point output by the second obtaining sub-module.

Optionally, in the correction module, four sides are formed by the parking lot corner points of the parking lot, four rectangles are obtained separately by taking one side in the four sides as a reference and taking the depth as a mean of the side length of the side, and a rectangle with the maximum confidence level on a thermodynamic diagram is taken from among the four rectangles and is used as the corrected parking lot.

Optionally, the confidence level of the rectangle on the thermodynamic diagram is obtained by means of the levels of confidence of the four corner points of the rectangle on the thermodynamic diagram.

Optionally, the confidence levels on the thermodynamic diagram are obtained by means of a corner point prediction model.

Optionally, in the correction module, two sides are selected from four sides formed by the parking lot corner points of the parking lot, a center line of the two sides is calculated, a parking lot entrance line segment of the parking lot is obtained according to a position relationship between a vehicle and the parking lot corner points of the parking lot, a point at which the center line intersects with the parking lot entrance line segment is obtained, and based on the position of the intersection point and the positions of the two sides, rectangular correction is performed on the parking lot corner point to obtain the corrected parking lot.

Optionally, if the two sides are parallel, a line which is parallel to the two sides and has an equal distance to the two sides is taken as a center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

Optionally, if the two sides are not parallel, an angular bisector of an angle formed by extension lines of the two sides is used as the center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

An aspect of the invention provides a computer-readable medium having a computer program stored thereon, where the computer program implements, when executed by a processor, a parking lot corner point correction system as described in claims.

An aspect of the invention provides a computer device, which includes a storage module, a processor, and a computer program stored on the storage module and executable on the processor, where the computer program implements, when executed by the processor, a parking lot corner point correction system as described.

An aspect of the invention provides a vehicle, which includes a parking lot corner point correction system as described in an aspect of the invention.

### BRIEF DESCRIPTION OF THE DRAWINGS

FIG. 1 is a schematic flowchart showing a parking lot corner point correction method in an implementation mode of the invention.

FIG. 2 is a schematic flowchart showing a parking lot corner point correction method in Embodiment 1 of the invention.

FIG. 3 is a schematic diagram showing rectangular correction in the parking lot corner point correction method in Embodiment 1 of the invention.

FIG. 4 is a schematic diagram showing a correction result obtained using the parking lot corner point correction method in Embodiment 1 of the invention.

FIG. 5 is a schematic flowchart showing a parking lot corner point correction method in Embodiment 2 of the invention.

FIG. 6 is a schematic diagram showing rectangular correction in two cases of parallel and non-parallel long sides in the parking lot corner point correction method in Embodiment 2 of the invention.

FIG. 7 is a schematic diagram showing one example of a correction result obtained using the parking lot corner point correction method in Embodiment 2 of the invention.

FIG. 8 is a schematic diagram showing another example of a correction result obtained using the parking lot corner point correction method in Embodiment 2 of the invention.

FIG. 9 is a structural block diagram showing a parking lot corner point correction system of the invention.

### DETAILED DESCRIPTION OF EMBODIMENTS

Some of multiple embodiments of the invention are introduced below and are intended to provide a basic understanding of the invention. They are not intended to confirm key or decisive elements of the invention or limit the scope of protection.

For the sake of brevity and illustrative purposes, this document mainly describes the principles of the invention with reference to its exemplary embodiments. However, those skilled in the art will readily recognize that the same principles can be equivalently applied to all types of parking lot corner point correction methods, parking lot corner point correction systems, and vehicles including the parking lot corner point correction system, and the same principles can be implemented therein. Any such changes do not depart from the true spirit and scope of this patent application.

The inventors of the invention have found that in the case of vertical, horizontal and small-angle inclined parking lots, there are currently also the following problems to be solved:

a phenomenon of jitter occurs in a parking lot detection result in a video;

a model detection result is a non-standard rectangle, which increases the difficulty in parking path planning; and

when a small-angle inclined parking lot is determined to be a vertical/horizontal parking lot, inclined parking is caused.

In order to solve the problems above, the invention provides a parking lot corner point correction method. The parking lot corner point correction method provided in the invention includes the following steps:

an obtaining step of obtaining a parking lot corner point of a parking lot; and

a correction step of performing, based on a position relationship between parking lot corner points of the parking lot, rectangular correction on the parking lot corner points to obtain a corrected parking lot.

Here, the parking lot corner points are obtained by detecting parking lot corner point coordinates in an image acquired by a camera, for example, obtained by means of a corner point detection model (based on a deep learning network). Here, preferably, the state of the parking lot corner points can be determined reasonably.

A parking lot corner point correction method in an implementation of the invention will be described below.

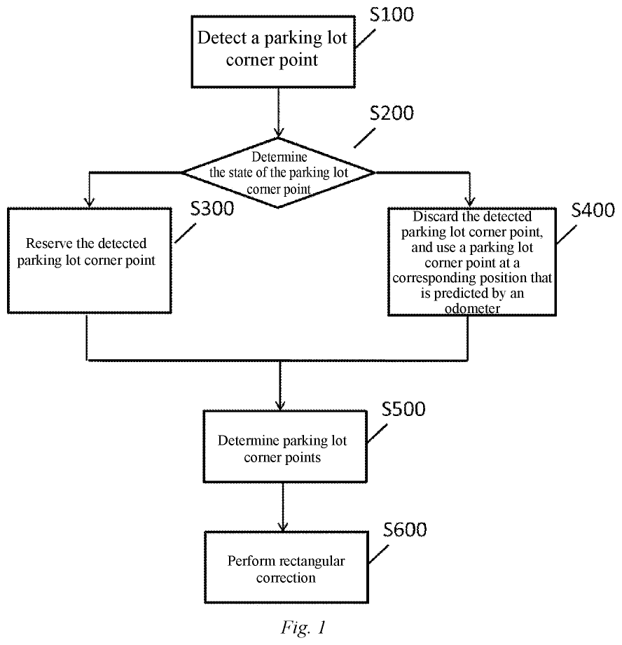

FIG. 1 is a schematic flowchart showing a parking lot corner point correction method in an implementation mode of the invention.

As shown in FIG. 1, the parking lot corner point correction method in an implementation of the invention includes:

step S100: detecting a parking lot corner point of a parking lot;

step S200: determining the state of the parking lot corner point, which specifically involves, for example, determining whether a corner point confidence level of the parking lot corner point meets a preset first threshold and whether a corner point offset thereof meets a preset second threshold, proceeding to step S300 if it is determined that the corner point confidence level meets the first threshold and the corner point offset meets the second threshold, otherwise, proceeding to step S400;

step S300: reserving the parking lot corner point detected in step S100;

step S400: discarding the parking lot corner point detected in step S100, and then using a parking lot corner point at a corresponding position that is predicted by an odometer, as the parking lot corner point of the parking lot;

step S500: determining four parking lot corner points based on step S300 or step S400; and

step S600: performing, based on a position relationship between parking lot corner points of the parking lot, rectangular correction on the parking lot corner points to obtain a corrected parking lot.

Here, determination of the state of the parking lot corner point mainly refers to determining whether the corner point detected by a model is reasonable. For example, a corner point tracked by the odometer should be at position (x, y), but there is a large offset in a model detection result (a threshold is preset). In this case, it is considered that the corner point detected by the model is less accurate, and the detection result of the corner point is discarded. A determination criterion may be set as follows: corner point confidence level>first threshold and corner point offset <second threshold. Here, the confidence level is output by the detection model, the detection model may represent possible coordinates (x, y) at which a point is a parking lot corner point and the possibility (confidence level) that the coordinates belong to the corner point, and the corner point offset refers to the distance between the detected corner point and a corner point predicted according to a result at a previous time.

Determining the state of the parking lot corner points is for the purpose of ensuring that the four corner points are as accurate as possible. For a parking lot corner point at a time t, there are three groups of data available, which are respectively as follows: (1) a parking lot corner point predicted by using the odometer from the beginning (which parking lot corner point has the lowest accuracy, but is not too far away from a target parking lot); (2) a parking lot corner point detected by the corner point detection model (which parking lot corner point may achieve the highest accuracy, but there may be a case where an individual corner point is deviated); and (3) a parking lot corner point predicted using the odometer according to a detection result at a time t-1 (that is, the previous time) (which parking lot corner point has a higher accuracy and is relatively stable). “Using a corner point at a corresponding position that is tracked by the odometer” above refers to the parking lot corner point predicted at the previous time in the case (3).

Next, two embodiments of the parking lot corner point correction method of the invention will be described.

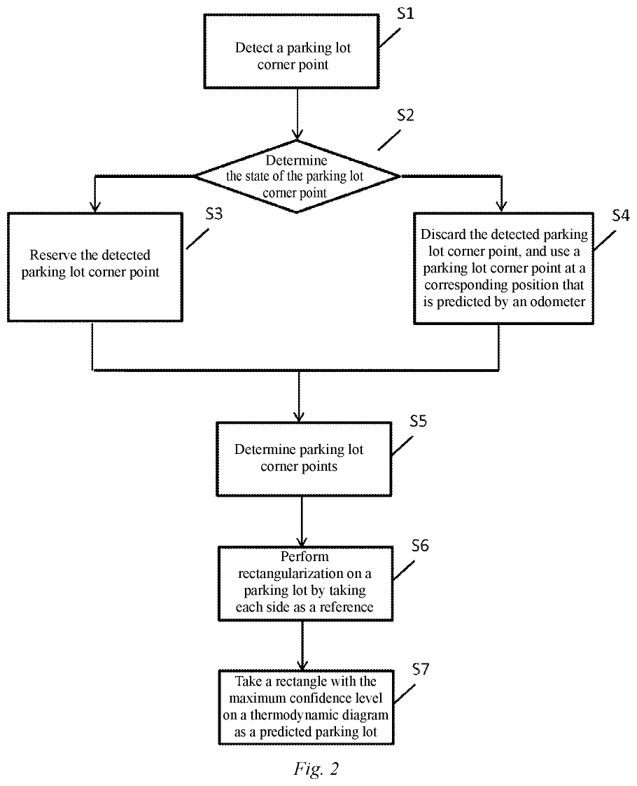

FIG. 2 is a schematic flowchart showing a parking lot corner point correction method in Embodiment 1 of the invention.

The parking lot corner point correction method provided in Embodiment 1 of the invention includes the following steps:

step S1: detecting a parking lot corner point of a parking lot;

step S2: determining the state of the parking lot corner point, which specifically involves, for example, determining whether a corner point confidence level of the parking lot corner point meets a preset first threshold and whether a corner point offset thereof meets a preset second threshold, proceeding to step S3 if it is determined that if it is determined that the corner point confidence level meets the preset first threshold and the corner point offset meets the preset second threshold , otherwise, proceeding to step S4;

step S3: reserving the parking lot corner point detected in step S1;

step S4: discarding the parking lot corner point detected in step S1, and then using a parking lot corner point at a corresponding position that is predicted by an odometer, as the parking lot corner point of the parking lot;

step S5: determining four parking lot corner points; and

step S6: forming four sides by the parking lot corner points of the parking lot, and obtaining four rectangles separately by taking one side in the four sides as a reference and taking the depth as a mean of the side length of the side; and

step S7: taking, from among the four rectangles and as the corrected parking lot, a rectangle with the maximum confidence level on a thermodynamic diagram. (i.e., a predicted parking lot), where the confidence level of the rectangle on the thermodynamic diagram can be obtained by means of the levels of confidence of the four corner points of the rectangle on the thermodynamic diagram (the confidence levels on the thermodynamic diagram are obtained by means of a corner point prediction model.).

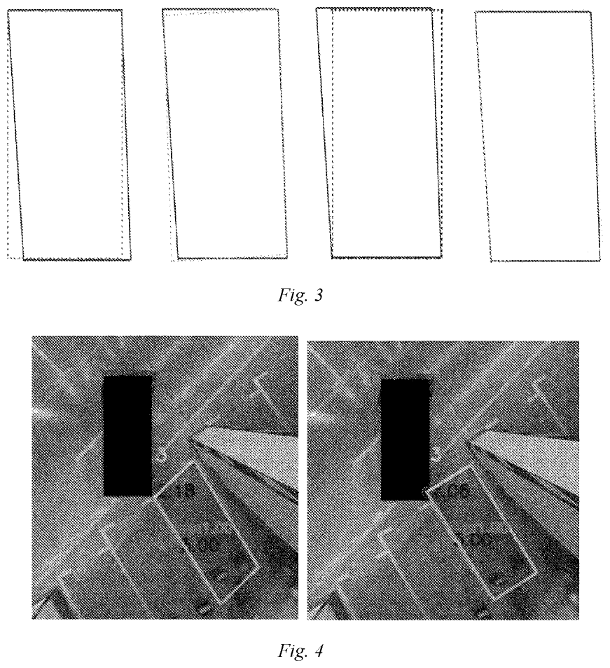

FIG. 3 is a schematic diagram showing rectangular correction in the parking lot corner point correction method in Embodiment 1 of the invention.

In the thermodynamic diagram of FIG. 3, an upper side, a right side, a lower side and a left side are taken as references in sequence from left to right. One side of the parking lot is selected, and by taking the side as a reference and taking the depth as a mean of the side length of the side, four rectangles are formed. For each rectangle, a confidence level of the rectangle may be obtained according to confidence levels of four corner points of the rectangle on the thermodynamic diagram, and by comparing the confidence levels of the four rectangles, the rectangle with the maximum confidence level is taken as a detection result to implement rectangularization.

FIG. 4 is a schematic diagram showing a correction result obtained using the parking lot corner point correction method in Embodiment 1 of the invention.

The parking lot corner point correction method in Embodiment 1 of the invention mainly solves the problem that, when there is an interference point, points obtained from the thermodynamic diagram lack shape information of the parking lot and there may be deviations in the detection of the parking lot corner point. In FIG. 4, there is a derivation in a parking lot corner point at the upper left corner in the left-side view, and the parking lot corner point may be corrected into a parking lot corner point at the upper left corner in the right-side view by using the correction method in Embodiment 1.

Therefore, as described above, according to the parking lot corner point correction method in Embodiment 1 of the invention, the influence of a deviation from the detection result can be reduced, and the parking accuracy can be improved.

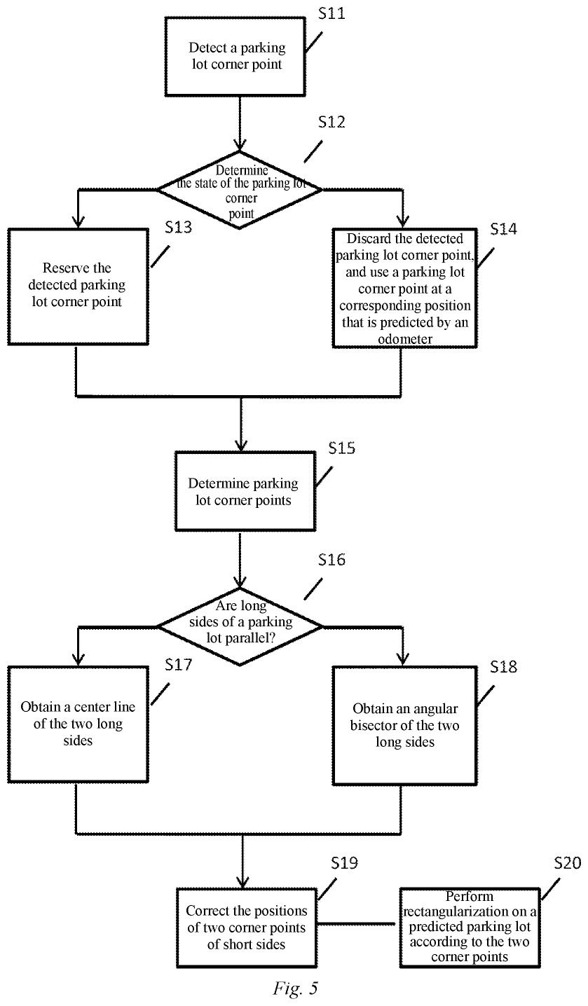

FIG. 5 is a schematic flowchart showing a parking lot corner point correction method in Embodiment 2 of the invention.

The parking lot corner point correction method provided in Embodiment 2 of the invention includes the following steps:

step S11: detecting a parking lot corner point of a parking lot;

step S12: determining the state of the parking lot corner point, which specifically involves, for example, determining whether a corner point confidence level of the parking lot corner point meets a preset first threshold and whether a corner point offset thereof meets a preset second threshold, proceeding to step S13 if it is determined that the corner point confidence level meets the first threshold and the corner point offset meets the second threshold, otherwise, proceeding to step S14;

step S13: reserving the parking lot corner point detected in step S11;

step S14: discarding the parking lot corner point detected in step S11, and then using a parking lot corner point at a corresponding position that is predicted by an odometer, as the parking lot corner point of the parking lot;

step S15: determining four parking lot corner points according to step S13 or step S14; and

step S16: determining whether long sides of the parking lot are parallel, if yes, proceeding to step S17, and if not, proceeding to step S18;

step S17: obtaining a center line of the two parallel long sides;

step S18: obtaining an angular bisector of an angle formed by the two long sides;

step S19: correcting the positions of two corner points of short sides; and

step S20: performing rectangularization on the parking lot according to the two corner points. FIG. 6 is a schematic diagram showing rectangular correction in two cases of parallel and non-parallel long sides in the parking lot corner point correction method in Embodiment 2 of the invention.

If the long sides are not parallel, as shown in the left-side view of FIG. 6, four corner points are sequentially C, B, 1, and 2 in the clockwise direction, and the arrow represents a traveling direction of a vehicle. B1 is a parking lot entrance line segment calculated according to a relative position of the vehicle with respect to the parking lot. A parking lot line BC and a parking lot line 12 at two sides of the parking lot entrance line segment B1 are selected, an intersection point A of extension lines of the two lines is calculated, and an angle bisector AD of an angle BA1 is obtained, where point D is a point at which the angle bisector intersects with the parking lot entrance line segment B 1, and a perpendicular line 0′1′ is drawn for AD through point D, where 0′ is a point at which the perpendicular line 0′1′ intersects with AC, and 1′ is a point at which the perpendicular line 0′1′ intersects with A2.

Here, assuming that the coordinates of point A are A (x_{A}, y_{A}), the coordinates of point B are B (x_{B}, y_{B}), the coordinates of point C are C (x_{C}, y_{C}), the coordinates of point D are D (x_{D}, y_{D}), the coordinates of point 0′ are 0′ (x_{0′}, y_{0′}), and the coordinates of point 1′ are 1′ (x_{1′}, y_{1′}), the coordinates of point 0′ and point 1′ may be calculated based on the coordinates of point A, point B, point C, and point D.

The following formulas represent the calculation process for solving x_{0′} and y_{0′} in the coordinates 0 (x_{0′}, y_{0′}) of point 0′, and the calculation process for solving x_{1′} and y_{1′} in the coordinates 1′ (x_{1′}, y_{1′}) of point 1′ is similar to the process for solving the coordinates 0′ (x_{0′}, y_{0′}) of point 0′.

$$\overline{AD} \cdot \overline{D 0} = 0$$

$$\overline{B 0} \cdot \overline{BC} = 0$$

$$\overline{AD} = ( {x}_{D} - {x}_{A} , {y}_{D} - {y}_{A} )$$

$$\overline{D {0}^{′}} = ( {x}_{{0}^{′}} - {x}_{D} , {y}_{{0}^{′}} - {y}_{0} )$$

$$\overline{B {0}^{′}} = ( {x}_{{0}^{′}} - {x}_{B} , {y}_{{0}^{′}} - {y}_{B} )$$

$$\overline{BC} = ( {x}_{C} - {x}_{B} , {y}_{C} - {y}_{B} )$$

$$\{ \begin{matrix}( {x}_{D} - {x}_{A} ) \cdot ( {x}_{{0}^{′}} - {x}_{D} ) + ( {y}_{D} - {y}_{A} ) \cdot ( {y}_{{0}^{′}} - {y}_{D} ) = 0 \\ ( {x}_{{0}^{′}} - {x}_{B} ) \cdot ( {y}_{C} - {y}_{B} ) - ( {x}_{C} - {x}_{B} ) \cdot ( {y}_{{0}^{′}} - {y}_{B} ) = 0\end{matrix} \\ \{ \begin{matrix}( {x}_{D} - {x}_{A} ) \cdot {x}_{{0}^{′}} + ( {y}_{D} - {y}_{A} ) \cdot {y}_{{0}^{′}} = ( {x}_{D} - {x}_{A} ) \cdot {x}_{D} + ( {y}_{D} - {y}_{A} ) \cdot {y}_{D} \\ ( {y}_{C} - {y}_{B} ) \cdot {x}_{{0}^{′}} - ( {x}_{C} - {x}_{B} ) \cdot {y}_{{0}^{′}} = ( {y}_{C} - {y}_{B} ) \cdot {x}_{B} - ( {x}_{C} - {x}_{B} ) \cdot {y}_{B}\end{matrix} \\ ( {x}_{D} - {x}_{A} ) \cdot {x}_{D} + ( {y}_{D} - {y}_{A} ) \cdot {y}_{D} = A 1 \\ ( {y}_{C} - {y}_{B} ) \cdot {x}_{B} - ( {x}_{C} - {x}_{B} ) \cdot {y}_{B} = A 2 \\ \{ \begin{matrix}( {x}_{D} - {x}_{A} ) ( {x}_{C} - {x}_{B} ) \cdot {x}_{{0}^{′}} + ( {y}_{D} - {y}_{A} ) ( {x}_{C} - {x}_{B} ) \cdot {y}_{{0}^{′}} = A 1 \cdot ( {x}_{C} - {x}_{B} ) \\ ( {y}_{C} - {y}_{B} ) ( {y}_{D} - {y}_{A} ) \cdot {x}_{{0}^{′}} - ( {x}_{C} - {x}_{B} ) ( {y}_{D} - {y}_{A} ) \cdot {y}_{{0}^{′}} = A 2 \cdot ( {y}_{D} - {y}_{A} )\end{matrix} \\ {x}_{{0}^{′}} = \frac{A 1 ( {x}_{C} - {x}_{B} ) + A 2 ( {y}_{D} - {y}_{A} )}{( {x}_{D} - {x}_{A} ) \cdot ( {x}_{C} - {x}_{B} ) + ( {y}_{C} - {y}_{B} ) \cdot ( {y}_{D} - {y}_{A} )} \\ \{ \begin{matrix}( {x}_{D} - {x}_{A} ) ( {y}_{C} - {y}_{B} ) \cdot {x}_{{0}^{′}} + ( {y}_{D} - {y}_{A} ) ( {y}_{C} - {y}_{B} ) \cdot {y}_{{0}^{′}} = A 1 \cdot ( {y}_{C} - {y}_{B} ) \\ ( {x}_{D} - {x}_{A} ) ( {y}_{C} - {y}_{B} ) \cdot {x}_{{0}^{′}} - ( {x}_{C} - {x}_{B} ) ( {x}_{D} - {x}_{A} ) \cdot {y}_{{0}^{′}} = A 2 \cdot ( {x}_{D} - {x}_{A} )\end{matrix} \\ {y}_{{0}^{′}} = \frac{A 1 ( {y}_{C} - {y}_{B} ) + A 2 ( {x}_{D} - {x}_{A} )}{( {y}_{D} - {y}_{A} ) \cdot ( {y}_{C} - {y}_{B} ) + ( {x}_{C} - {x}_{C} - {x}_{B} ) \cdot ( {x}_{D} - {x}_{A} )}$$

If the long sides are parallel, as shown in the right-side view of FIG. 6, four corner points are sequentially C, B, 1, and 2 in the clockwise direction, and the arrow represents a traveling direction of a vehicle. B1 is a parking lot entrance line segment calculated according to a relative position of the vehicle with respect to the parking lot. A parking lot line BC and a parking lot line 12 at two sides of the parking lot entrance line segment B1 are selected. Since the parking lot line BC is parallel to the parking lot line 12, a center line AD is drawn for the two parallel lines, a point at which the center line AD intersects with the parking lot entrance line segment B1 is point D, and a perpendicular line 0′1′ is drawn for AD through point D, where 0′ is a point at which the perpendicular line 0′1′ intersects with the parking lot line BC, and 1′ is a point at which the perpendicular line 0′1′ intersects with the parking lot line 12. Similarly, it is also possible to calculate coordinates of point 0′ and point 1′ based on point A, point B, point C, point D.

In this way, after the positions of the two corner points of the short sides are corrected in two cases of parallel and non-parallel long sides, the parking lot may be subjected to rectangularization according to the corrected positions of the two corner points, so as to obtain the corrected parking lot.

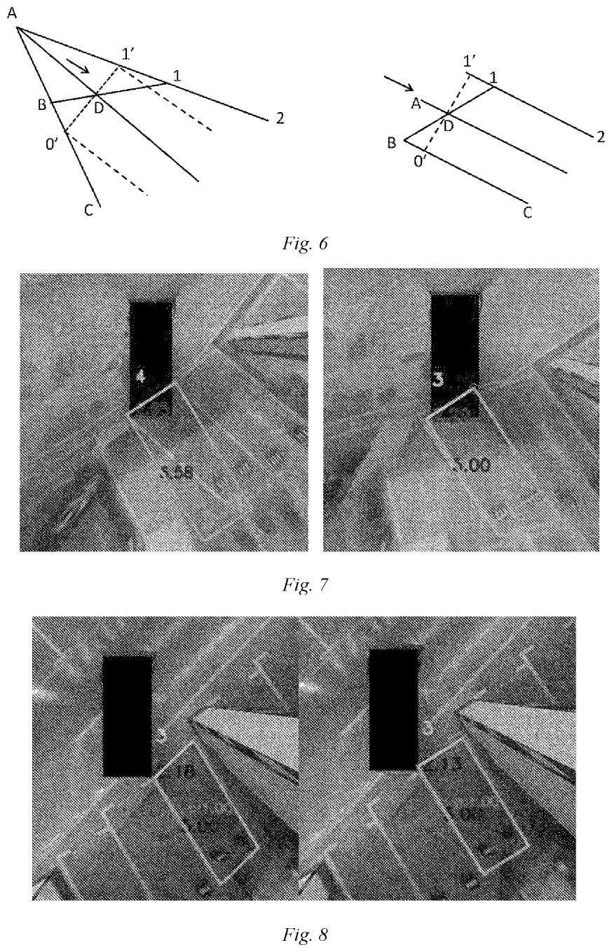

FIG. 7 is a schematic diagram showing one example of a correction result obtained using the parking lot corner point correction method in Embodiment 2 of the invention.

FIG. 7 shows the case of a small-angle rhombic parking lot. Here, so-called “small-angle rhombic parking lot” means that an angle formed by the vehicle and the entrance of the parking lot is a non-obtuse angle. As an example, when an angle of inclination of the rhombic parking lot is less than 75 degrees, in which case the rhombic parking lot is as shown in the left-side view of FIG. 7, the small-angle inclined parking lot is wrongly determined as a vertical parking lot or a parallel parking lot, and there may be errors directly depending on the effect of rectangularization of the first two corner points. A correction effect shown in the right-side view of FIG. 7 is obtained after correction using the correction method in Embodiment 2.

FIG. 8 is a schematic diagram showing another example of a correction result obtained using the parking lot corner point correction method in Embodiment 2 of the invention. FIG. 8 shows a correction effect, shown in the right-side view of FIG. 8, obtained after correction using the correction method in Embodiment 2 in the case of false detection of a corner point of the parking lot, such as an error in the parking lot caused by an error in the detection of an upper left corner point in the left-side view of FIG. 8.

Next, a parking lot corner point correction system of the invention will be described.

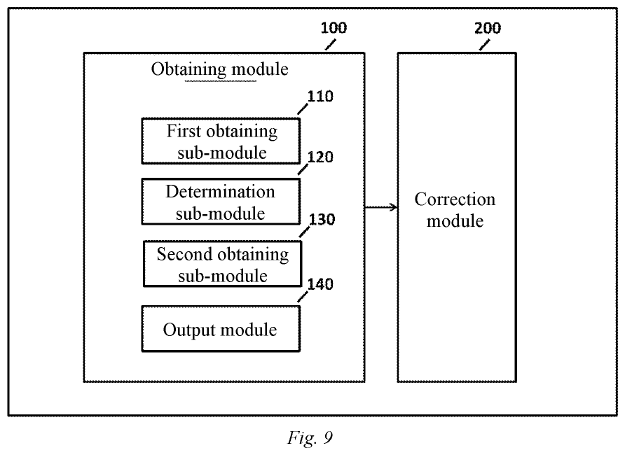

FIG. 9 is a structural block diagram showing a parking lot corner point correction system of the invention.

As shown in FIG. 9, the invention provides a parking lot corner point correction system, the system including:

an obtaining module 100 for obtaining a parking lot corner point of a parking lot; and

a correction module 200 for performing, based on a position relationship between parking lot corner points of the parking lot, rectangular correction on the parking lot corner points to obtain a corrected parking lot.

The obtaining module 100 includes:

a first obtaining sub-module 110 configured to obtain a parking lot corner point of a parking lot;

a determination sub-module 120 configured to determine whether a corner point confidence level of the parking lot corner point acquired by the first obtaining sub-module meets a first threshold and whether a corner point offset of the parking lot corner point meets a second threshold, and then output a determination result; and

a second obtaining sub-module 130 configured to obtain a parking lot corner point at a corresponding position that is predicted by an odometer; and

an output module 140 configured to provide, based on the determination result from the determination sub-module and to the correction module, the parking lot corner point output by the first obtaining sub-module or the parking lot corner point output by the second obtaining sub-module.

Optionally, in the correction module 200, four sides are formed by the parking lot corner points of the parking lot, four rectangles are obtained separately by taking one side in the four sides as a reference and taking the depth as a mean of the side length of the side, and a rectangle with the maximum confidence level on a thermodynamic diagram is taken from among the four rectangles and is used as the corrected parking lot. The confidence level of the rectangle on the thermodynamic diagram is obtained by means of the confidence levels of the four corner points of the rectangle on the thermodynamic diagram. The confidence levels on the thermodynamic diagram are obtained by means of a corner point prediction model.

Optionally, in the correction module 200, two sides are selected from four sides formed by the parking lot corner points of the parking lot, a center line of the two sides is calculated, a parking lot entrance line segment of the parking lot is obtained according to a position relationship between a vehicle and the parking lot corner points of the parking lot, a point at which the center line intersects with the parking lot entrance line segment is obtained, and based on the position of the intersection point and the positions of the two sides, rectangular correction is performed on the parking lot corner point by using a geometric relationship in FIG. 6 to obtain the corrected parking lot.

If the two sides are parallel, a line which is parallel to the two sides and has an equal distance to the two sides is taken as a center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

If the two sides are not parallel, an angular bisector of an angle formed by extension lines of the two sides is used as the center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

The invention further provides a computer-readable medium having a computer program stored thereon, where the computer program implements, when executed by a processor, a parking lot corner point correction system as described above.

The invention further provides a computer device, which includes a storage module, a processor, and a computer program stored on the storage module and executable on the processor, where the computer program implements, when executed by the processor, a parking lot corner point correction system as described above.

The invention further provides a vehicle, the vehicle including a parking lot corner point correction system as described above.

The examples above mainly illustrate a parking lot corner point correction method, a parking lot corner point correction system, and a vehicle including the parking lot corner point correction system in the invention. Although only some specific implementations of the invention are described, a person of ordinary skill in the art should understand that the invention may be implemented in multiple other forms without departing from the essence and scope of the invention. Accordingly, the presented examples and implementations are considered to be illustrative rather than restrictive, and the invention may encompass various modifications and replacements without departing from the spirit and scope of the invention that are defined by the appended claims.

1. A parking lot corner point correction method, comprising:
an obtaining step of obtaining a parking lot corner point of a parking lot; and
a correction step of performing, based on a position relationship between parking lot corner points of the parking lot, rectangular correction on the parking lot corner points to obtain a corrected parking lot.

2. The parking lot corner point correction method according to claim 1, wherein the obtaining step comprises:
a first obtaining sub-step of obtaining a parking lot corner point of a parking lot;
a determination sub-step of determining whether a corner point confidence level of the parking lot corner point meets a first threshold and whether a corner point offset of the parking lot corner point meets a second threshold, and jumping to the correction step if it is determined that the corner point confidence level of the parking lot corner point meets the first threshold and the corner point offset of the parking lot corner point meets the second threshold, otherwise, proceeding to a second obtaining sub-step; and
the second obtaining sub-step of discarding the parking lot corner point of the parking lot that is detected in the first obtaining sub-step, and then using a parking lot corner point at a corresponding position that is predicted by an odometer, as the parking lot corner point of the parking lot.

3. The parking lot corner point correction method according to claim 1, wherein
the correction step comprises:
forming four sides by the parking lot corner points of the parking lot, and obtaining four rectangles separately by taking one side in the four sides as a reference and taking the depth as a mean of the side length of the side; and
taking, from among the four rectangles and as the corrected parking lot, a rectangle with the maximum confidence level on a thermodynamic diagram.

4. The parking lot corner point correction method according to claim 3, wherein
the confidence level of the rectangle on the thermodynamic diagram is obtained by means of the confidence levels of the four corner points of the rectangle on the thermodynamic diagram.

5. The parking lot corner point correction method according to claim 3, wherein
the confidence levels on the thermodynamic diagram are obtained by means of a corner point prediction model.

6. The parking lot corner point correction method according to claim 1, wherein
the correction step comprises:
selecting two sides from four sides formed by the parking lot corner points of the parking lot, and calculating a center line of the two sides;
obtaining a parking lot entrance line segment of the parking lot according to a position relationship between a vehicle and the parking lot corner point of the parking lot;
obtaining a point at which the center line intersects with the parking lot entrance line segment; and
based on the position of the intersection point and the positions of the two sides, performing rectangular correction on the parking lot corner point by using a geometric relationship to obtain the corrected parking lot.

7. The parking lot corner point correction method according to claim 6, wherein
if the two sides are parallel, a line which is parallel to the two sides and has an equal distance to the two sides is taken as a center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

8. The parking lot corner point correction method according to claim 6, wherein
if the two sides are not parallel, an angular bisector of an angle formed by extension lines of the two sides is used as the center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

9. A parking lot corner point correction system, comprising:
an obtaining module for obtaining a parking lot corner point of a parking lot; and
a correction module for performing, based on a position relationship between parking lot corner points of the parking lot, rectangular correction on the parking lot corner points to obtain a corrected parking lot.

10. The parking lot corner point correction system according to claim 9, wherein the obtaining module comprises:
a first obtaining sub-module configured to obtain a parking lot corner point of a parking lot;
a determination sub-module configured to determine whether a corner point confidence level of the parking lot corner point acquired by the first obtaining sub-module meets a first threshold and whether a corner point offset of the parking lot corner point meets a second threshold, and then output a determination result; and
a second obtaining sub-module configured to obtain a parking lot corner point at a corresponding position that is predicted by an odometer; and
an output module configured to provide, based on the determination result from the determination sub-module and to the correction module, the parking lot corner point output by the first obtaining sub-module or the parking lot corner point output by the second obtaining sub-module.

11. The parking lot corner point correction system according to claim 9, wherein
in the correction module, four sides are formed by the parking lot corner points of the parking lot, four rectangles are obtained separately by taking one side in the four sides as a reference and taking the depth as a mean of the side length of the side, and a rectangle with the maximum confidence level on a thermodynamic diagram is taken from among the four rectangles and is used as the corrected parking lot.

12. The parking lot corner point correction system according to claim 11, wherein
the confidence level of the rectangle on the thermodynamic diagram is obtained by means of the confidence levels of the four corner points of the rectangle on the thermodynamic diagram.

13. The parking lot corner point correction system according to claim 12, wherein
the confidence levels on the thermodynamic diagram are obtained by means of a corner point prediction model.

14. The parking lot corner point correction system according to claim 9, wherein
in the correction module, two sides are selected from four sides formed by the parking lot corner points of the parking lot, a center line of the two sides is calculated, a parking lot entrance line segment of the parking lot is obtained according to a position relationship between a vehicle and the parking lot corner points of the parking lot, a point at which the center line intersects with the parking lot entrance line segment is obtained, and based on the position of the intersection point and the positions of the two sides, rectangular correction is performed on the parking lot corner point to obtain the corrected parking lot.

15. The parking lot corner point correction system according to claim 14, wherein
if the two sides are parallel, a line which is parallel to the two sides and has an equal distance to the two sides is taken as a center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

16. The parking lot corner point correction system according to claim 15, wherein
if the two sides are not parallel, an angular bisector of an angle formed by extension lines of the two sides is used as the center line, a perpendicular line is drawn for the center line from the intersection point, points at which the perpendicular line respectively intersects with the two sides are used as corrected parking lot corner points, and rectangularization is performed based on the corrected parking lot corner points to obtain the corrected parking lot.

17. A computer device, comprising a storage module, a processor, and a computer program stored on the storage module and executable on the processor, wherein the computer program implements, when executed by the processor, a parking lot corner point correction method, the method comprising:
an obtaining step of obtaining a parking lot corner point of a parking lot; and
a correction step of performing, based on a position relationship between parking lot corner points of the parking lot, rectangular correction on the parking lot corner points to obtain a corrected parking lot.
